(19) United States
(12) Patent Application Publication
(10) Pub. No.: US 2018/0351978 A1
(43) Pub. Date: Dec. 6, 2018

(54) CORRELATING USER INFORMATION TO A TRACKED EVENT

(71) Applicant: Microsoft Technology Licensing, LLC, Redmond, WA (US)

(72) Inventors: Ido Y. PREIZLER, Kiryat Ono (IL); Avihai BERKOVITZ, Tel Aviv (IL); Shai KAPLAN, Tel Aviv (IL); Yaniv J. OLIVER, Tel Aviv (IL)

(73) Assignee: Microsoft Technology Licensing, LLC, Redmond, WA (US)

(21) Appl. No.: 15/613,995

(22) Filed: Jun. 5, 2017

(51) Int. Cl. H04L 29/06; H04L 12/26

(52) U.S. Cl. CPC H04L 63/1425; H04L 43/0876; H04L 63/20; H04L 63/1408; H04L 63/1416

(57) ABSTRACT

According to examples, an apparatus may include a processor and a memory having instructions that are to cause processor to access an event log that lists an event item corresponding to an event that occurred at a network appliance, determine that the event item matches an item listed in a user log that lists records of user information and a plurality of items, in which the records correspond to user events in a network, identify the user information corresponding to the matching item, determine a confidence level that the identified user information corresponds to the event item, determine whether the confidence level exceeds a certain threshold value, in response to a determination that the confidence level exceeds the certain threshold, correlate the user information to the event item, and insert an entry into a database that the user information corresponds to the event item.

### BACKGROUND

Computer network administration often includes operations to maximize authorized access without generating excessive network traffic due to maintaining a record of users authorized to access a particular network resource and frequently updating the records. In simple cases, each resource maintains its own list of authorized users, and upon receiving a request for service checks the list to prevent security breaches due to access by unauthorized users. Users of a computer network are often organized into groups, which generally reduces the number of list entries that have to be checked by a resource (and updated by the system) prior to granting access to the resource.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a network environment in which an apparatus for correlating user information to a tracked event may be implemented in accordance with an embodiment of the present disclosure;

FIG. 2 shows a block diagram of an apparatus for correlating user information to a tracked event in accordance with an embodiment of the present disclosure;

FIG. 3 depicts a flow diagram of a method for correlating information in an event log with information in a user log in accordance with an embodiment of the present disclosure; and

FIGS. 4 and 5, respectively, depict flow diagrams of methods for determining a confidence level that a second item corresponds to an event item and for determining whether the confidence level exceeds a certain threshold in accordance with embodiments of the present disclosure.

### DETAILED DESCRIPTION

For simplicity and illustrative purposes, the present disclosure is described by referring mainly to embodiments. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Network appliances that provide network services, such as cloud services, may generate and maintain event logs. As the network appliances are available from multiple manufacturers, they often generate the event logs to include different types of information or information that are in different formats with respect to each other. As such, information from the event log of one of the network appliances may not provide a comprehensive level of detain and/or information that may be in an undesirable format.

Disclosed herein are apparatuses and methods for correlating information from an event log to information contained in another log, which is referenced herein as a user log, to enrich the information in the event log. That is, information tracked and stored by one apparatus into one log may be used to augment or enrich the information tracked and stored by another apparatus into another log. However, the information contained in one log may not automatically be correlated with information contained in the other log. Instead, a confidence level corresponding to the correlation may be determined and the information contained in the logs may be correlated with each other if the determined confidence level exceeds a certain threshold value. If the determined confidence level falls below the certain threshold value, then the other information may not be correlated with the information contained in the log. In instances in which the information from a first log is correlated to the information contained in a second log, the information contained in the second log may be used to add to and/or replace the information in the first log.

Through implementation of the apparatuses and methods disclosed herein, the information contained in event logs that contain various types of information may be normalized with respect to each other such that operators may be presented with common views of information from the event logs. Additionally, a more comprehensive set of information may be identified, which may aid in the examination of specific users' behavior and pinpointing of usage trends to actual users. In addition, or alternatively, network appliances may use the comprehensive set of information to execute operations on data packets communicated to the network appliances by users corresponding to the user information. By way of example, a network appliance may determine that a user who is using particular user information, e.g., a particular user name, a particular user identifier, or the like, may be a malicious user and may discard the data packets received from that user.

A technical problem may be that apparatuses, such as network appliances, may not be able to obtain adequate information from processing data packets to identify particular users that communicated the data packets to the apparatuses. In this regard, the apparatuses may not be able to apply policies to the data packets based upon the identities of particular users, which may result in security failures or other problems in a network containing the network appliances. A technical solution to the technical problem afforded by the apparatuses and methods disclosed herein is that failures, such as security failures, in the network may be reduced and/or eliminated. That is, the users that have communicated data packets to the apparatuses may be identified and policies may be applied on those data packets as well as any data packets sent in the future based upon the users' identities to reduce and/or eliminate the security failures in the network.

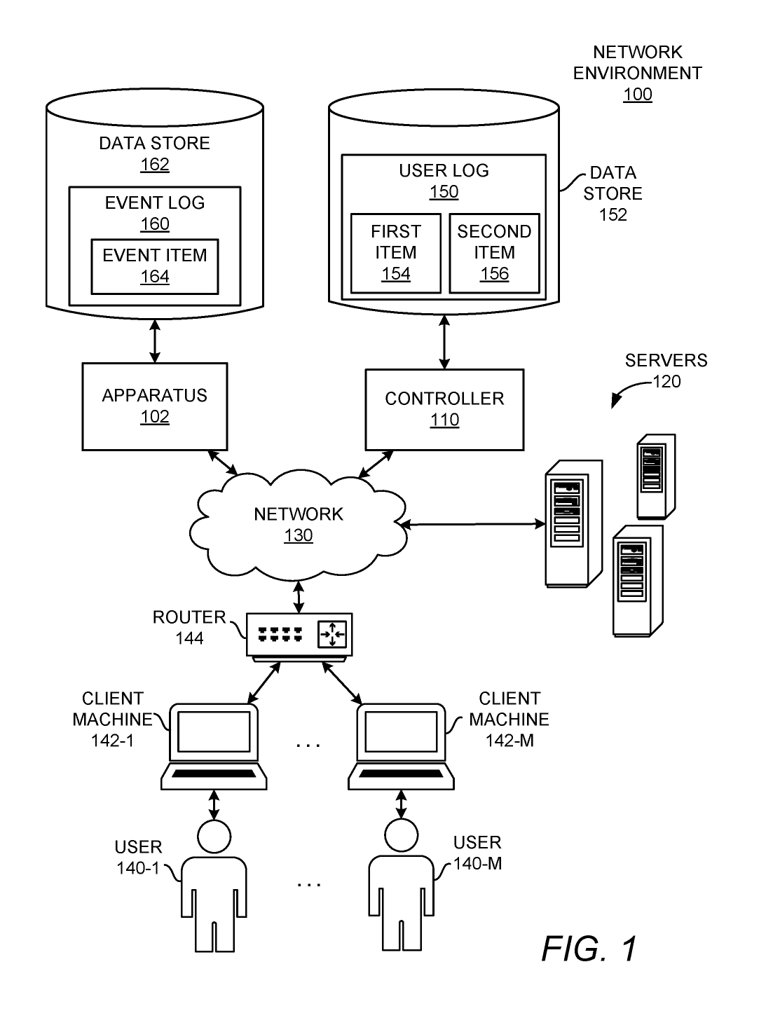

Reference is made first to FIG. 1, which shows a block diagram of a network environment 100 in which an apparatus 102 for correlating user information to a tracked event may be implemented, in accordance with an embodiment of the present disclosure. It should be understood that the network environment 100 depicted in FIG. 1 may include additional components and that some of the components described herein may be removed and/or modified without departing from scopes of the network environment 100.

As shown in FIG. 1, in addition to the apparatus 102, the network environment 100 may also include a controller 110 and a plurality of servers 120, which may all be in communication with each other over a network 130. The network 130 may represent a local area network, a wide area network, the Internet, or combinations thereof. The apparatus 102, the controller 110, and the servers 120 may be geographically collocated and may be part of the same network and thus, the network 130 may include a local area network (LAN). In other examples, the apparatus 102, the controller 110, and/or the servers 120 may be located in different geographic locations with respect to each other and the network 130 may include a wide area network or the Internet. The network 130 may also be a combination of a LAN and the Internet. In any regard, the apparatus 102, the controller 110, and/or the servers 120 may be part of a common domain and/or may be part of a common cloud computing architecture. By way of particular example, the network environment 100 may be a cloud-based network of an organization.

As also shown in FIG. 1, a plurality of users 140-1 to 140-N, in which the variable “N” may represent a value greater than one, may access the apparatus 102, the controller 110, and/or the servers 120 via the network 130, which may collectively be termed network components. The users 140 may access the network components through respective client machines 142-1 to 142-M, in which the variable “M” may represent a value greater than one. The users 140 may access the network components to access data on the servers 120, to execute services hosted on the servers 120 (e.g., access a web page, execute an application, etc.) via the client machines 142. The client machines 142 may be laptop computers, smartphones, tablet computers, desktop computers, or the like, and may access the network through a router 144, which may also be an access point.

Prior to accessing the network 130, the client machines 142 may be assigned internet protocol (IP) addresses, which the client machines 142 may include in data packets that the client machines 142 communicate through the network 130. The client machines 142 may be assigned a different IP address each time that the client machines 142 access the network 130. Additionally, the same IP address may be assigned to different client machines 142 at the same or at different times. As such, a particular IP address may not necessarily be assigned to a particular client machine 142 or user 140 and thus, an IP address may not be used to accurately identify the client machine 142 of a user 140 that has communicated particular data packets to the network components.

According to examples, the network components may be part of a domain and the users 140 may have respective user accounts that have previously been set up for the users 140. For security purposes, the user accounts may be associated with respective identifying information of the users 140, such as the user names, passwords, security questions and answers, and the like. The users 140 may be required to be authenticated by entering their identifying information in order to log into the domain and access resources on the domain, such as services that the servers 120 provide. When the users 140 enter their identifying information, an authentication server may authenticate the users 140, in which the authentication server may be one of the servers 120. For instance, the authentication server may implement a remote authentication dial-in user service (RADIUS) protocol.

The controller 110, which may be a domain controller, a network manager, a software defined networking controller, or the like, may track and maintain a record of when users log into and log off the domain. In some examples, the controller 110 may be a standalone device and may be one of the servers 120. In other examples, the controller 110 may be the authentication server. In yet other examples, the controller 110 may be a set of machine readable instructions (or virtual machines) that may be executed on a server or distributed across multiple servers. In yet further examples, the controller 110 may represent another data source, such as a network appliance in the domain.

In any of the examples discussed above, the controller 110 may track and store user login and log out events of users 140, in which the events may include the identifying information of users as the users log into and log off the domain. Particularly, the controller 110 may store the identifying information of a user 140 in a user log 150, such as an Identity Management system (e.g., Active Directory), stored in a data store 152. As shown, the controller 110 may store a first item of information 154 (also referenced herein as a first item 154) and a second item of information 156 (also referenced herein as a second item 156). By way of example, the first item 154 may be an IP address associated with a user event and the second item 156 may be a user information (e.g., a user name) of the user event. The user log 150 may also store additional items of information. For instance, each record in the user log 150 may be a tuple of a timestamp, an IP address, and username. The data store 152 may be a Random Access Memory (RAM), an Electrically Erasable Programmable Read-Only Memory EEPROM), a storage device, an optical disc, and the like. Although the data store 152 has been depicted as being separate from the controller 110, in some examples, the data store 152 may be integrated with the controller 110.

Packets of data that the users 140 communicate to the network components may be directed to the apparatus 102. The apparatus 102 may be a network appliance such as a firewall device, a switch, a router, a server, combinations thereof, or the like. In some examples, the apparatus 102 may perform a security operation on the data packets, such as by processing the data packets for intrusion detection, intrusion prevention, malicious attack detection, or the like. In addition or in other examples, the apparatus 102 may perform a switching and/or a routing operation on the data packets, such as by processing the data packets to identify addresses of next network appliances that the data packets are to be forwarded and forwarding the data packets to the identified addresses. In further examples, the network appliances may host services such as applications that the users 140 may access and execute.

In any of the examples above, the apparatus 102 may track and record information pertaining to events associated with the received data packets. The events may include, for instance, each instance in which the users 140 communicate the data packets to the apparatus 102. In other examples, the events may be an occurrence of an error, receipt of a particular type of data packet, receipt of data packets exceeding a certain size from a particular IP address, receipt of a number of data packets from a particular IP address that exceeds a certain number, or the like. In any regard, the apparatus 102 may enter the information (also recited herein as event items 164) pertaining to the events in an event log 160 stored in a data store 162, which may be a Random Access Memory (RAM), an Electrically Erasable Programmable Read-Only Memory EEPROM), a storage device, an optical disc, and the like. Although the data store 162 has been depicted as being separate from the apparatus 102, in some examples, the data store 162 may be integrated with the apparatus 102.

The apparatus 102 may include a parser to extract data from the data packets, e.g., metadata, and to enter the extracted data into the event log 160. The extracted data may include some or all of a timestamp at which the data packets were received, the IP address of a source client machine 142, the user name of a user 140, the IP address of a destination client machine 142, a destination universal resource locator (URL), a total number of bytes uploaded by a source client machine 142, a total number of bytes downloaded by a destination client machine 142, an indication as to whether access to the apparatus 102 was allowed or denied, and the like. In some examples, the apparatus 102 may extract less than all of the information available from the data packets and may store the extracted information in the event log 160 as event items 164. In some examples, the apparatus 102 may extract all of the information available from the data packets but may store less than all of the extracted information in the event log 160. In any of these examples, the logs in the event log 160 may not include all of the available information in the data packets. By way of particular example, the apparatus 102 may store an event item 164 pertaining to a source client machine 142 IP address but not the user name of a user 140 of the source client machine 142.

Additionally, the apparatus 102 may not extract and/or store the same types of information as other apparatuses. That is, different types of apparatuses as well as apparatuses from different manufacturers may store different ones of the information available from the data packets with respect to each other. Moreover, different apparatuses may store the events in different formats with respect to each other. For instance, some apparatuses may store the event information in comma-delimited format while other apparatuses may store the event information as free lines of text. As such, the event logs from multiple apparatuses may not include the same type of information and may not be in a standardized format with respect to each other.

According to embodiments, the event information contained in the event log 160 may be enriched such that, for instance, additional information pertaining to the data packets may be correlated to the event information. The enrichment may include identifying missing information, e.g., information from the data packets that were not entered into the event log 160. In addition or in other examples, the enrichment may include identifying information similar to the information included in the event log 160 but in a different format. For instance, the event log 160 may include an abbreviated version or a formatted version of the information and the enrichment may include identifying a complete version or a differently formatted version of the information.

The information for the enrichment may be obtained from other sources of information in the network environment 100. For instance, the enrichment information may be obtained from the user log 150 that the controller 110 may maintain. In other examples, the enrichment information may be obtained from other sources such as the event logs of other apparatuses. As discussed herein, the information contained in the other sources of information may be matched to the information contained in the event log 160 based upon a determination as to the likelihood that the information contained in the other sources of information correlates to the information contained in the event log 160. That is, for instance, a determination as to whether the second item 156 in the user log 150 corresponds to the event item 164 in the event log 160 may be determined based upon a determined confidence level.

The enriched information along with the information in the event log 160 may be presented to a user 140 to provide the user 140 with more comprehensive information regarding events that have occurred at the apparatus 102. In addition or in other examples, the apparatus 102 may use the enriched information to execute an operation based on and/or on data packets communicated to the apparatus 102. In other words, the apparatus 102 may implement various policies on data packets received at the apparatus 102 based upon the enriched information. In examples in which the apparatus 102 is a firewall device, the apparatus 102 may use the enriched information to identify particular users and may block access to the network components to the identified particular users and/or may discard data packets received from the identified particular users. In other examples in which the apparatus 102 is a switch or a router, the apparatus 102 may use the enriched information to control where the data packets received from particular users are directed. For instance, the apparatus 102 may direct all of the data packets received from particular users to a network component to undergo deep packet inspection.

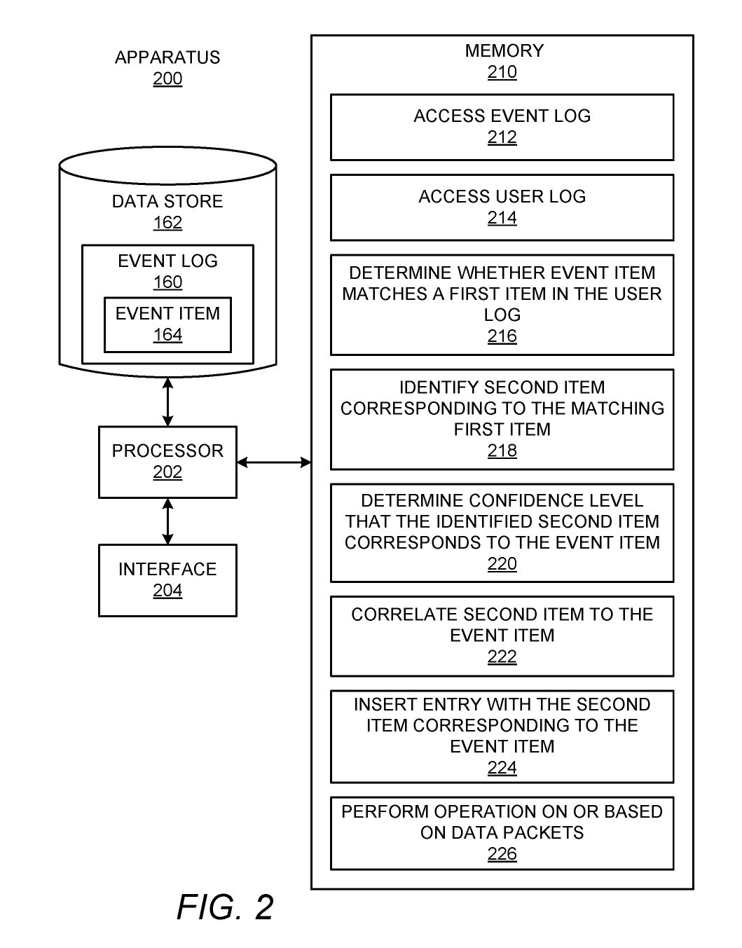

Turning now to FIG. 2, there is shown a block diagram of an apparatus 200 for correlating user information to a tracked event according to an embodiment of the present disclosure. The apparatus 200 may be equivalent to the apparatus 102 discussed above with respect to FIG. 1 and the description of the apparatus 200 is made with respect to FIGS. 1 and 2. In this regard, the apparatus 200 may be a network appliance that may perform functions such as security, routing, application servicing, combinations thereof, and the like.

As shown in FIG. 2, the apparatus 200 may include a processor 202 that may control operations of the apparatus 200. The processor 202 may be a semiconductor-based microprocessor, a central processing unit (CPU), an application specific integrated circuit (ASIC), a field-programmable gate array (FPGA), and/or other suitable hardware device. The processor 202 may access a data store 162, which may be a Random Access Memory (RAM), an Electrically Erasable Programmable Read-Only Memory EEPROM), a storage device, an optical disc, and the like. As discussed above, the processor 202 may store an event item 164 in an event log 160 in the data store 162. The processor 202 may also access an interface 204 through which the processor 202 may communicate with other components over a network such as the network 130 depicted in FIG. 1. The interface 204 may be any suitable hardware and/or software that enable the processor 202 to communicate with the other components.

The apparatus 200 may also include a memory 210 that may have stored thereon machine readable instructions 212-226 (which may also be termed computer readable instructions) that the processor 202 may execute. The memory 210 may be an electronic, magnetic, optical, or other physical storage device that contains or stores executable instructions. The memory 210 may be, for example, Random Access memory (RAM), an Electrically Erasable Programmable Read-Only Memory (EEPROM), a storage device, an optical disc, and the like. The memory 210, which may also be referred to as a computer readable storage medium, may be a non-transitory machine-readable storage medium, where the term “non-transitory” does not encompass transitory propagating signals.

The processor 202 may fetch, decode, and execute the instructions 212 to access the event log 160, which may list an event item 164 corresponding to an event that occurred at the apparatus 200. The event item 164 may be, for instance, an IP address of a client machine 142 and the event may be any of the events discussed herein. The processor 202 may fetch, decode, and execute the instructions 214 to access a user log 150 that lists records of user information and a plurality of items 154, 156, in which the records correspond to user events in a network. The user information may include information such as a username, a security identifier, or the like, of a user 140 and the plurality of items may include another identifying item of information pertaining to the user 140. The processor 202 may fetch, decode, and execute the instructions 216 to determine whether the event item 164 matches a first item 154 in the user log 150. The processor 202 may fetch, decode, and execute the instructions 218 to identify a second item 156 that corresponds to the matching first item 154, in which the second item 156 may be the user information. The processor 202 may fetch, decode, and execute the instructions 220 to determine a confidence level that the identified second item 156 corresponds to the event item 164. The processor 202 may fetch, decode, and execute the instructions 222 to insert an entry into a database that the second item 156 (e.g., user information) corresponds to the event item 164 to enrich the information contained in the event log 160. The processor 202 may fetch, decode, and execute the instructions 224 to perform an operation on or based on data packets communicated to the apparatus 200 by a user 140 corresponding to the second item 156 (e.g., user information).

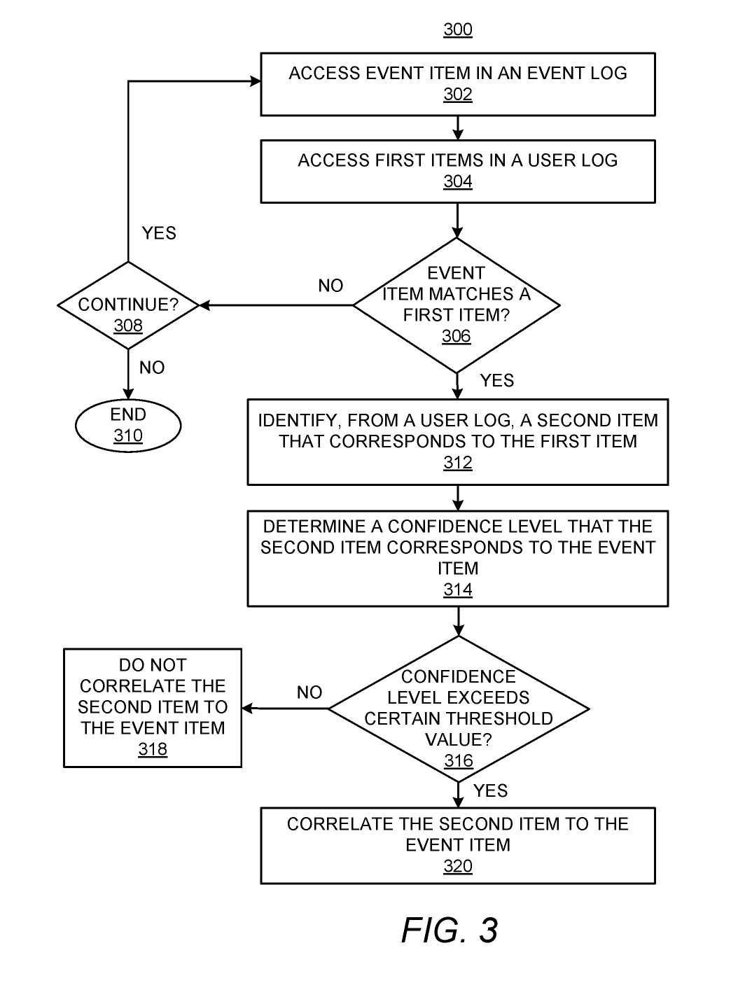

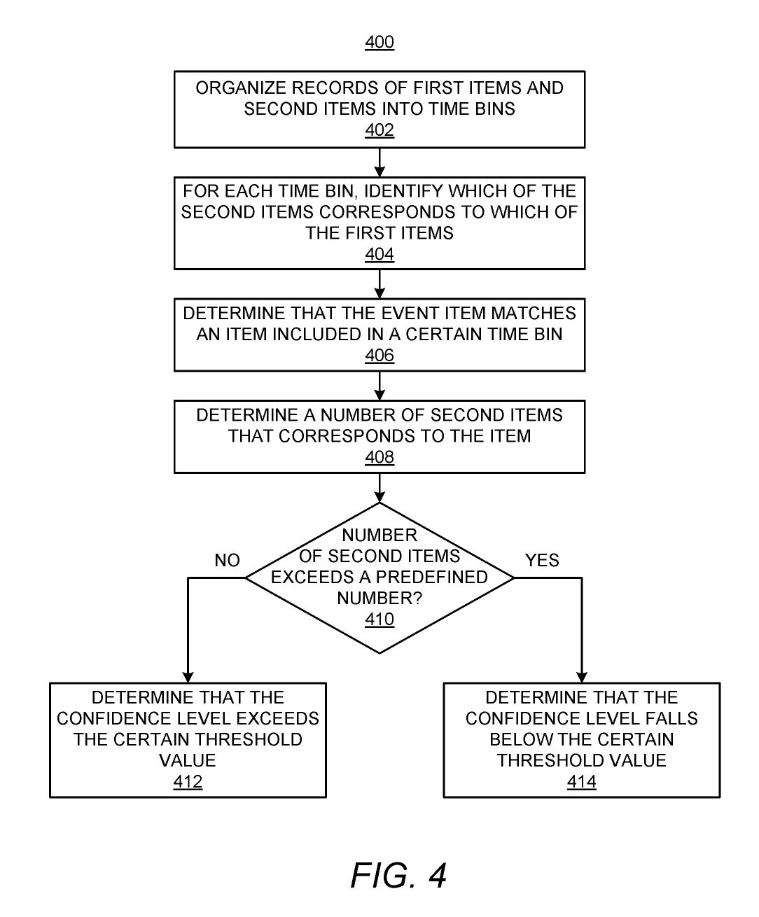

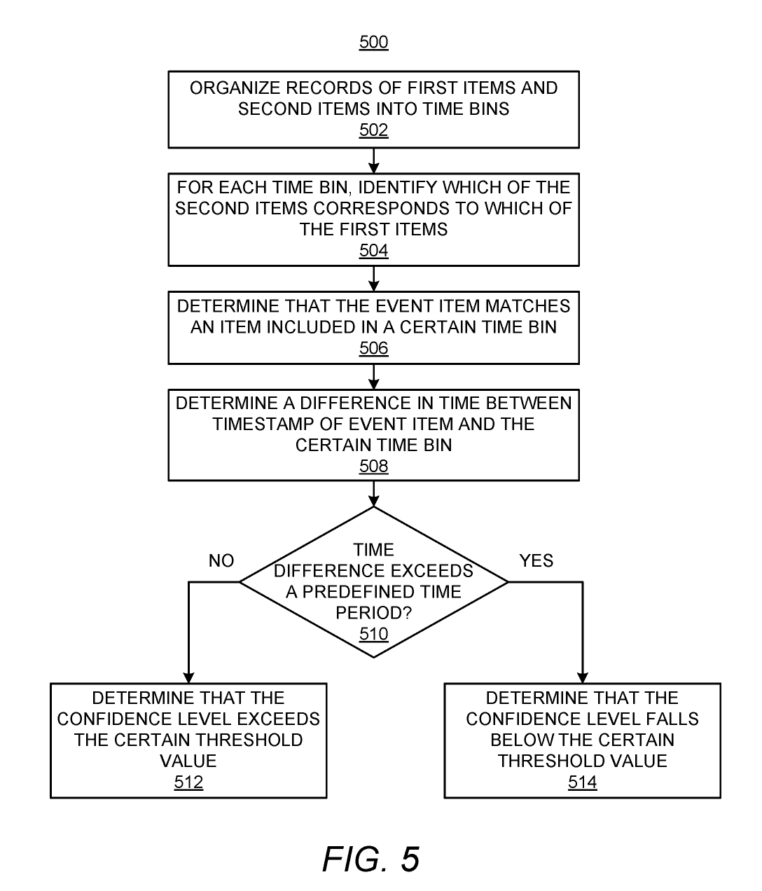

Various manners in which the processor 202 may operate to correlate information in an event log 160 with information in a user log 150 are discussed in greater detail with respect to the methods 300-500 depicted in FIGS. 3-5. Particularly, FIG. 3 depicts a flow diagram of a method 300 for correlating information in an event log 160 maintained by an apparatus 200 with information in a user log 150 maintained by another source according to embodiments of the present disclosure. FIGS. 4 and 5, respectively, depict flow diagrams of methods 400 and 500 for determining a confidence level that a second item 156 corresponds to an event item 164 and for determining whether the confidence level exceeds a certain threshold level according to embodiments of the present disclosure. It should be understood that the methods 300-500 depicted in FIGS. 3-5 may include additional operations and that some of the operations described therein may be removed and/or modified without departing from scopes of the methods 300-500. The descriptions of the methods 300-500 are also made with reference to the features depicted in FIGS. 1 and 2 for purposes of illustration.

With reference first to FIG. 3, at block 302, the processor 202 may execute the instructions 212 to access an event log 160 that lists an event item 164 corresponding to an event that occurred at the apparatus 200. The event may an occurrence that the processor 202 may track such as the transmission of data packets to the apparatus 200 and/or receipt of data packets from the apparatus 200. The event may also be an event pertaining to a detected failure, an intrusion detection, an abnormal function, or the like. The event item 164 may be an item of information pertaining to the event such as an item of information available from metadata corresponding to the data packets. By way of example, the event item 164 may be an IP address of a client machine 142 from which the apparatus 200 received the data packets.

At block 304, the processor 202 may execute the instructions 214 to access a user log 150 that lists records of first items 154 and second items 156 corresponding to user events in a network or domain. The first items 154 or simply “items” may be the same type of information as the event item 164. As such for instance the first items 154 may be IP addresses of client machines 142 through which users 140 have logged into the domain over a period of time. The second items 156 are also described as user information and may be other information pertaining to the client machines 142 and/or the users 140 that may not be included in the event log 160. For instance, the second items 156 may be user names, user security identifiers, security answers and questions, and the like. Additionally, for each user event that is recorded in the user log 150, the user event record may identify a particular second item 156 corresponding to each of the first items 154.

As discussed above, a controller 110 may generate and update the user log 150 with entries directed to instances in which the users 140 log into and/or log off a particular domain in which the apparatus 200 is a member. In these examples, the user log 150 may be an Identity Management system (e.g., Active Directory). In other examples, the user log 150 may be generated and maintained by another apparatus in the domain. The other apparatus may be similar to the apparatus 200 but may store different information pertaining to the data packets in the user log 150 as compared to the information stored in the event log 160. The other apparatus may additionally or in other examples store similar information as is stored in the event log 160 but in a different format.

At block 306, the processor 202 may execute the instructions 216 to determine whether the event item 164 from the event log 160 matches a first item 154 in the user log 150. By way of example, the processor 202 may determine whether an IP address listed in the event log 160 matches any of the IP addresses listed in the user log 150. In response to a determination that the event item 164 does not match any of the first items in the user log 150, the processor 202 may determine whether the method 300 is to continue at block 308. In response to a determination that the method 300 is to end, the processor 202 may end the method 300 at block 310. However, in response to a determination that the method 300 is to continue, the processor 202 may repeat blocks 302-308. The determination as to whether to continue the method 300 may depend upon whether the processor 202 is to continually determine correlations of other data to event items in the event log or to determine a correlation of a particular event item 164.

With reference back to block 306, in response to a determination that the event item 164 matches one of the first items 154 in the user log 150, the processor 202 may execute the instructions 218 to identify a second item 156 that corresponds to the matching first item 154 at block 312. By way of example in which the first item 154 is an IP address, the second item 156 may be a user name corresponding to the user event from which that IP address was identified.

At block 314, the processor 202 may execute the instructions 220 to determine a confidence level that the identified second item 156 corresponds to the event item 164. As discussed herein, multiple client machines 142 may be assigned the same first item 154, e.g., the same IP address. As such, the second item 156 may not necessarily correspond to the same user 140 or client machine 142 at all times. The processor 202 may determine the confidence level as to whether the identified second item 156 corresponds to the event item 164 based upon a number of factors. The factors may include, for instance, the number of second items 156 (e.g., user information) identified in the user log 150 as corresponding to the first item 154 (e.g., IP address), the difference in the times at which the event item 164 was entered into the event log 160 and at which the identified second item 156 was entered into the user log 150, etc. Based upon one or more of the factors, the processor 202 may determine the confidence level, for instance, as a score between 0 and 100 or some other scoring system. Examples in which the processor 202 may determine the confidence level are discussed in greater detail below with respect to FIGS. 4 and 5.

At block 316, the processor 202 may execute the instructions 220 to determine whether the determined confidence level exceeds a certain threshold value. In other words, the processor 202 may determine whether there is a high likelihood that the second item 156 corresponds to the event item 154 as may occur when the determined confidence level exceeds the certain threshold value. The certain threshold value may be user defined and may be determined through testing. For instance, the certain threshold value may be lower when less accuracy is desired and may be higher when greater accuracy is desired.

In response to a determination that the determined confidence level does not exceed the certain threshold value, the processor 202 may not correlate the second item 156 to the event item 164 as indicated at block 318. Thus, for instance, the processor 202 may determine that a second item 156 corresponding to the event item 164 may not have been identified in the user log 150. However, in response to a determination that the determined confidence level does exceed the certain threshold value, the processor 202 may correlate the second item 156 to the event item 164 at block 320.

In addition, the processor 202 may execute the instructions 224 to insert an entry into a database that the second item 156 corresponds to the event item 164. The database may include an identification of the event item 164, the second item 156, as well as other information. By way of particular example, the database may include enriched information pertaining to events tracked at the apparatus 200, e.g., information in addition to the information that the processor 202 of the apparatus 200 collects and records. In some examples, the information contained in the database may be outputted to provide additional data pertaining to the events tracked at the apparatus 200.

The processor 202 may additionally and/or alternatively perform an operation on and/or based on data packets received from and/or directed to a particular user 140 based upon the correlation between the second item 156 and the event item 164. That is, for instance, the particular user 140 may not be identified from the event item 164 but may be identified from the second item 156, which may be a user name that has been uniquely assigned to the particular user 140. The operation may include issuing an alert and/or blocking access to the user 140 in response to a determination that the user 140 has downloaded more than a predefined amount of data, has attempted to send data to more than a preset number of machines, etc.

Although not shown, following either or both of blocks 318 and 320, the processor 202 may access another user log from another source and may repeat blocks 306-320 on the other user log to, for instance, obtain additional information. In other examples, the processor 202 may end the method 300 following either or both of blocks 318 and 320. In still other examples, the processor 202 may repeat the method 300 for additional event items 164 in the event log 160 at block 302.

Turning now to FIGS. 4 and 5, the methods 400 and 500 describe operations that may be performed as parts of blocks 314 and 316 in the method 300. That is, the methods 400 and 500 describe example operations in which a confidence level may be determined at block 314 and a determination may be made at block 316 as to whether the determined confidence level exceeds a certain threshold value.

With reference to FIG. 4, at block 402, the processor 202 may organize the records of the first items 154 and the second items 156 into a plurality of time bins, in which each of the time bins includes records of first items 154 and second items 156 corresponding to user events in the network or domain that occurred during a predefined time frame. As noted above, in some examples, the records in the user log 150 may include timestamps, which may be used to include the records into the time bins. The predefined time frames may each be for a set duration of time, e.g., for one hour, for two hours, or the like, and may encompass parts of a day, a day, or multiple days. In addition, at block 404, the processor 202 may identify, for each of the time bins, which of the second items 156 corresponds to which of the first items 154. That is, the processor 202 may identify a first item 154 and a second item 156 pair for each of the user events identified in each of the time bins.

At block 406, the processor 202 may determine that the event item 164 matches a first item 154 of a record included in a certain time bin of the plurality of time bins. For instance, the processor 202 may determine the certain time bin that is closest in time to a time at which the event item 164 was identified and/or stored in the event log 160.

At block 408, the processor 202 may determine a number of second items 156 that corresponds to the first item 154. As discussed herein, a plurality of second items 156, e.g., user information such as user names, may correspond to the same IP address. That is, for instance, different users may use the same IP address to log into a domain and thus, user events may be tracked to have the same IP address, but with different user information. In any regard, at block 408, the processor 202 may determine the number of second items 156 that corresponds to the first 154 item in a particular time bin.

At block 410, the processor 202 may determine whether the determined number of second items 156 exceeds a predefined number. The predefined number may be user defined and may depend upon a desired level of accuracy in determining second items 156 that correspond to event items 164. For instance, the predefined number may be higher in instances in which the desired level of accuracy is lower and the predefined number may be lower in instances in which the desired level of accuracy is higher. By way of particular example, the predefined number is about 3.

In response to a determination that the determined number of second items 156 falls below the predefined number, the processor 202 may determine that the confidence level that the second item 156 corresponds to the event item 164 exceeds the certain threshold value as indicated at block 412. In other words, the processor 202 may determine that the confidence level exceeds the certain threshold value at block 316 in FIG. 3. At block 412, therefore, a determination may be made that there is a sufficiently high likelihood that the second item 156 corresponds to the event item 164. In other words, for instance, there is a sufficiently high likelihood that the user information corresponding to an IP address of a user event also corresponds to an event logged into an event log 160. As such, the second item 156 may be identified as corresponding to the event item 164 and the event item 164 stored in the event log 160 may be enriched with the second item 156.

However, in response to a determination that the determined number of second items 156 exceeds the predefined number, the processor 202 may determine that the confidence level that the second item 156 corresponds to the event item 164 falls below the certain threshold value as indicated at block 414. In other words, the processor 202 may determine that the confidence level falls below the certain threshold value at block 316 in FIG. 3. At block 414, therefore, a determination may be made that a sufficiently high likelihood that the second item 156 corresponds to the event item is missing. In other words, for instance, the user information corresponding to an IP address of a user event does not, with a sufficiently high degree of confidence, correspond to an event logged into an event log 160 by the apparatus 200. As such, the second item 156 may not be identified as corresponding to the event item 164.

With reference now to FIG. 5, at block 502, the processor 202 may organize the records of the first items 154 and the second items 156 into a plurality of time bins. In addition, at block 504, the processor 202 may identify, for each of the time bins, which of the second items 156 corresponds to which of the first items 154. Moreover, at block 506, the processor 202 may determine that the event item 164 matches a first item 154 of a record included in a certain time bin of the plurality of time bins. Blocks 502-506 may respectively be equivalent to blocks 402-406 discussed above with respect to the method 400.

At block 508, the processor 202 may determine a difference in time between a timestamp of an event at which the event 164 item was identified and the certain time bin. Particularly, for instance, the processor 202 may determine the difference in time between the timestamp and a time pertaining to the time frame of the certain time bin, e.g., a beginning of the time frame, a middle of the time frame, the end of the time frame, or the like.

At block 510, the processor 202 may determine whether the difference in time exceeds a predefined time period. The predefined time period may be user defined and may depend upon a desired level of accuracy in determining second items 156 that correspond to event items 164. For instance, the predefined time period may be higher in instances in which the desired level of accuracy is lower and the predefined time period may be lower in instances in which the desired level of accuracy is higher. That is, the shorter the time difference, the greater the likelihood that the second item 156 corresponds to the event item 164.

In response to a determination that the time difference does falls below the predefined period of time, the processor 202 may determine that the confidence level that the second item 156 corresponds to the event item 154 exceeds the certain threshold value as indicated at block 512. In other words, the processor 202 may determine that the confidence level exceeds the certain threshold value at block 316 in FIG. 3. At block 512, therefore, a determination may be made that there is a sufficiently high likelihood that the second item 156 corresponds to the event item 164. In other words, for instance, there is a sufficiently high likelihood that the user information corresponding to an IP address of a user event also corresponds to an event logged into an event log 160. As such, the second item 156 may be identified as corresponding to the event item 164 and the event item 164 stored in the event log 160 may be enriched with the second item 156.

However, in response to a determination that the time difference exceeds the predefined time period, the processor 202 may determine that the confidence level that the second item 156 corresponds to the event item 164 falls below the certain threshold value as indicated at block 514. In other words, the processor 202 may determine that the confidence level falls below the certain threshold value at block 316 in FIG. 3. At block 514, therefore, a determination may be made that a sufficiently high likelihood that the second item 156 corresponds to the event item 154 is missing. In other words, for instance, the user information corresponding to an IP address of a user event does not, with a sufficiently high degree of confidence, correspond to an event logged into an event log 160. As such, the second item 156 may not be identified as corresponding to the event item 164.

Some or all of the operations set forth in the methods 300-500 may be contained as utilities, programs, or subprograms, in any desired computer accessible medium. In addition, the methods 300-500 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus for correlating user information to a tracked event, said apparatus comprising:
a processor; and
a memory on which is stored machine readable instructions that are to cause processor to:
access an event log that lists an event item corresponding to an event that occurred at a network appliance;
determine that the event item matches an item listed in a user log that lists records of user information and a plurality of items, wherein the records correspond to user events in a network;
identify the user information corresponding to the matching item;
determine a confidence level that the identified user information corresponds to the event item;
determine whether the confidence level exceeds a certain threshold value;
in response to a determination that the confidence level exceeds the certain threshold, correlate the user information to the event item; and
insert an entry into a database that the user information corresponds to the event item.

2. The apparatus according to claim 1, wherein the instructions are further to cause the processor to:
perform an operation on data packets communicated to the network appliance by a user corresponding to the user information.

3. The apparatus according to claim 1, wherein the user log is an Identity Management system that records user logins to a domain in the network.

4. The apparatus according to claim 1, wherein instructions are further to cause processor to:
organize the records of user information and items into a plurality of time bins, wherein each of the plurality of time bins includes records of user information and items corresponding to user events in the network that occurred during a predefined time frame; and
for each of the plurality of time bins, identify which of the user information corresponds to which of the items.

5. The apparatus according to claim 4, wherein the instructions are further to cause the processor to:
determine that the event item matches an item of a record included in a certain time bin of the plurality of time bins;
determine a number of user information that corresponds to the item in the certain time bin; and
determine whether the confidence level exceeds the certain threshold based upon the determined number of user information.

6. The apparatus according to claim 5, wherein the instructions are further to cause the processor to:
determine that the confidence level exceeds the certain threshold in response to the determined number of user information falling below a predefined number; and
determine that the confidence level falls below the certain threshold in response to the determined number of user information exceeding the predefined number.

7. The apparatus according to claim 5, wherein the event log additionally lists a time-stamp of a time at which the event at the network appliance occurred, and wherein the instructions are further to cause the processor to:
identify within which of the predefined time frames of the plurality of time bins that the time-stamp of the time at which the event at the network appliance occurred falls; and
determine the match between the event item and the item of the record in the certain time bin corresponding to the identified predefined time frame.

8. The apparatus according to claim 4, wherein the event log additionally lists a time-stamp of a time at which the event at the network appliance occurred, and wherein the instructions are further to cause the processor to:
determine that the event item matches an item of a record included in a certain time bin of the plurality of time bins;
determine a difference in time between the time-stamp and the predefined time frame of the certain time bin; and
determine whether the confidence level exceeds the certain threshold based upon the determined difference in time.

9. The apparatus according to claim 8, wherein the instructions are further to cause the processor to:
determine that the confidence level exceeds the certain threshold in response to the determined difference in time falling below a predefined time period; and
determine that the confidence level falls below the certain threshold in response to the determined difference in time exceeding the predefined time period.

10. A method for correlating information in an event log with information in a user log, said method comprising:
accessing an event log that lists an event item corresponding to an event that occurred at the network appliance;
determining whether the event item matches a first item of a plurality of first items listed in a user log that lists records of second items and first items corresponding to user events in a network;
in response to a determination that the event item matches the first item of the plurality of first items, identifying the second item corresponding to the matching first item;
determining, by a processor, a confidence level that the identified second item corresponds to the event item;
determining, by the processor, whether the confidence level exceeds a certain threshold value;
in response to a determination that the confidence level exceeds the certain threshold, correlating, by the processor, the second item to the first event information; and
inserting, by the processor, an entry into a database that the second item corresponds to the event item.

11. The method according to claim 10, wherein the second item comprises a user name, the method further comprising:
executing a policy on data packets communicated to the network appliance by a user corresponding to the second item.

12. The method according to claim 10, further comprising:
organizing the records of the second items and the first items corresponding to user events in a network into a plurality of time bins, wherein each of the plurality of time bins includes records of the second items and the first items corresponding to user events in the network that occurred during a predefined time frame; and
for each of the plurality of time bins, identifying which of the second items corresponds to which of the first item.

13. The method according to claim 12, further comprising:
determining that the event item matches a first item of a record included in a certain time bin of the plurality of time bins;
determining a number of second items that corresponds to the first item in the certain time bin;
determining whether the determined number of second items exceeds a predefined number;
in response to a determination that the determined number of second items falls below the predefined number, determining that the confidence level exceeds the certain threshold; and
in response to a determination that the determined number of second items exceeds the predefined number, determining that the confidence level falls below the certain threshold.

14. The method according to claim 10, wherein the event log additionally lists a time-stamp of a time at which the event at the network appliance occurred, the method further comprising:
determining that the event items matches a first item of a record included in a certain time bin of the plurality of time bins;
determining a difference in time between the time-stamp and the predefined time frame of the certain time bin; and
determining whether the confidence level exceeds the certain threshold based upon the determined difference in time.

15. The method according to claim 14, further comprising:
determining that the confidence level exceeds the certain threshold in response to the determined difference in time falling below a predefined time period; and
determining that the confidence level falls below the certain threshold in response to the determined difference in time exceeding the predefined time period.

16. A non-transitory computer readable medium on which is stored machine readable instructions that when executed by a processor, cause the processor to:
access an event log that lists an event IP address corresponding to an event that occurred at a network appliance;
determine that the event IP address matches an IP address of IP addresses listed in a user log that lists records of user information and IP addresses corresponding to user events in a network;
identify the user information corresponding to the matching IP address;
determine a confidence level that the identified user information corresponds to the event IP address;
determine whether the confidence level exceeds a certain threshold value;
in response to a determination that the confidence level exceeds the certain threshold, correlate the user information to the event IP address; and
execute a policy pertaining to data packets communicated to the network appliance by a user corresponding to the user name.

17. The non-transitory computer readable medium according to claim 16, wherein the instructions are further to cause the processor to:
organize the records of user information and IP addresses into a plurality of time bins, wherein each of the plurality of time bins includes records of user information and IP addresses corresponding to user events in the network that occurred during a predefined time frame; and
for each of the plurality of time bins, identify which of the user information corresponds to which of the IP addresses.

18. The non-transitory computer readable medium according to claim 17, wherein the instructions are further to cause the processor to:
determine that the event IP address matches an IP address of a record included in a certain time bin of the plurality of time bins;
determine a number of user information that match the IP address in the certain time bin;
determine whether the determined number of user information that corresponds to the IP address in the certain time bin;
in response to a determination that the determined number of user information falls below the predefined number, determine that the confidence level exceeds the certain threshold; and
in response to a determination that the determined number of user information exceeds the predefined number, determine that the confidence level falls below the certain threshold.

19. The non-transitory computer readable medium according to claim 17, wherein the event log additionally lists a time-stamp of a time at which the event at the network appliance occurred, wherein the instructions are further to cause the processor to:
identify within which of the predefined time frames of the plurality of time bins that the time-stamp of the time at which the event at the network appliance occurred falls; and
determine the match between the event IP address and the IP address of the record in the certain time bin corresponding to the identified predefined time frame.

20. The non-transitory computer readable medium according to claim 19, wherein the instructions are further to cause the processor to:
determine that the event IP address matches an IP address of a record included in a certain time bin of the plurality of time bins;
determine a difference in time between the time-stamp and the predefined time frame of the certain time bin;
in response to a determination that the difference in time falling below a predefined time period, determine that the confidence level exceeds the certain threshold; and
in response to a determination that the difference in time exceeding the predefined time period, determine that the confidence level falls below the certain threshold.
